(19) United States
(12) Patent Application Publication
(10) Pub. No.: US 2017/0154762 A1
(43) Pub. Date: Jun. 1, 2017

(54) TRAP REPLACEMENT MECHANISM AND MICROPARTICLE COMPOSITION ANALYZING APPARATUS

(71) Applicant: FUJI ELECTRIC CO., LTD., Kanagawa (JP)

(72) Inventors: Naoki TAKEDA, Yokohama-city (JP); Yoshiki HASEGAWA, Hino-city (JP); Kazuhiro KOIZUMI, Sagamihara-city (JP); Takamasa ASANO, Hino-city (JP)

(21) Appl. No.: 15/333,192

(22) Filed: Oct. 25, 2016

(30) Foreign Application Priority Data
Dec. 1, 2015 (JP) 2015-235098

(51) Int. Cl. H01J 49/04; B23P 19/04

(52) U.S. Cl. CPC H01J 49/0422; H01J 49/0495; B23P 19/04

(57) ABSTRACT

In a microparticle composition analyzing apparatus, when a depressurized chamber is opened to atmospheric pressure in order to replace a trap, a certain amount of time is needed to vacuum out the entire depressurized chamber again and return the depressurized chamber to the reduced pressure state, and this causes an increase in the dead time of the measurement. Provided is a trap replacement mechanism including a rod that supports a trap for trapping microparticles and a connection portion that includes at least a portion of an auxiliary space connected to a depressurized space in which the trap is provided. The trap can be withdrawn from the depressurized space to the auxiliary space side and opened to atmospheric pressure while the depressurized space is kept in a depressurized state, by moving the rod.

The contents of the following Japanese patent application are incorporated herein by reference:

NO. 2015-235098 filed on Dec. 1, 2015.

### BACKGROUND

1. Technical Field

The present invention relates to a trap replacement mechanism and a microparticle composition analyzing apparatus.

2. Related Art

There has been increasing concern about the health effects of particulate matters (aerosols) in the atmosphere, and apparatuses are being developed to analyze the components, concentrations, and the like of these matters. According to the technology described in Patent Document 2, for example, particles are captured in a trap having a high collection efficiency, these particles are heated and vaporized through irradiation with an energy beam such as a laser, the gas resulting from the vaporization is ionized, and components of the ionized gas are analyzed using mass spectrometry.

Patent Document 1: US Patent Document No. 6040574

Patent Document 2: International Publication WO 2011/114587

The trap structurally and chemically changes due to melting when the energy beam is receive, accumulation of heat shock, and the like, and cannot maintain its original performance capability after extended use. Therefore, it is necessary to periodically replace the trap, and after the depressurized chamber is opened up to atmospheric pressure during the replacement, a certain amount of time is needed to vacuum out the entire depressurized chamber again and return the depressurized chamber to the reduced pressure state, and this causes an increase in the dead time of the measurement.

### SUMMARY

According to a first aspect of the present invention, provided is a trap replacement mechanism comprising a rod that supports a trap for trapping microparticles and a connection portion that includes at least a portion of an auxiliary space connected to a depressurized space in which the trap is provided. The trap can be withdrawn from the depressurized space to the auxiliary space side and opened to atmospheric pressure while the depressurized space is kept in a depressurized state, by moving the rod.

The connection portion may include a bellows mechanism, and an internal space of the bellows mechanism may also function as the auxiliary space. The connection portion may include a coupling portion for connecting to a depressurized chamber forming the depressurized space, and at least a portion of the auxiliary space may be formed inside the coupling portion.

The rod may be capable of adjusting an arrangement position of the trap within the depressurized space. The rod may be capable of supporting and being separated from the trap within the depressurized space.

The trap replacement mechanism may comprise an auxiliary pump that depressurizes the auxiliary space. The trap replacement mechanism may comprise a gate valve that switches between a connected state and an isolated state realized between the depressurized space and the auxiliary space. The gate valve may switch from the connected state to the isolated state after the trap has withdrawn into the auxiliary space.

According to a second aspect of the present invention, provided is a microparticle composition analyzing apparatus comprising the trap replacement mechanism described above; the trap an exhaust apparatus that depressurizes the depressurized space; an introducing section that acquires and converges a gaseous sample containing the microparticles and discharges the converged gaseous sample toward the trap; a laser device that irradiates the trap with laser; and a gas analyzer that analyzes a sample gas generated as a result of the irradiation with the laser.

The summary clause does not necessarily describe all necessary features of the embodiments of the present invention. The present invention may also be a sub-combination of the features described above.

### BRIEF DESCRIPTION OF THE DRAWINGS

FIG. 1 is a schematic view representing a microparticle composition analyzing apparatus when in use.

FIG. 2 is a schematic view representing the microparticle composition analyzing apparatus during replacement of the trap.

FIG. 3 is an external perspective view of the replacement mechanism.

FIG. 4 is a schematic view for describing the aerodynamic lens.

FIG. 5 is a schematic view representing a microparticle composition analyzing apparatus 100′ according to a modification.

FIG. 6 is an external perspective view of the replacement mechanism according to a modification.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

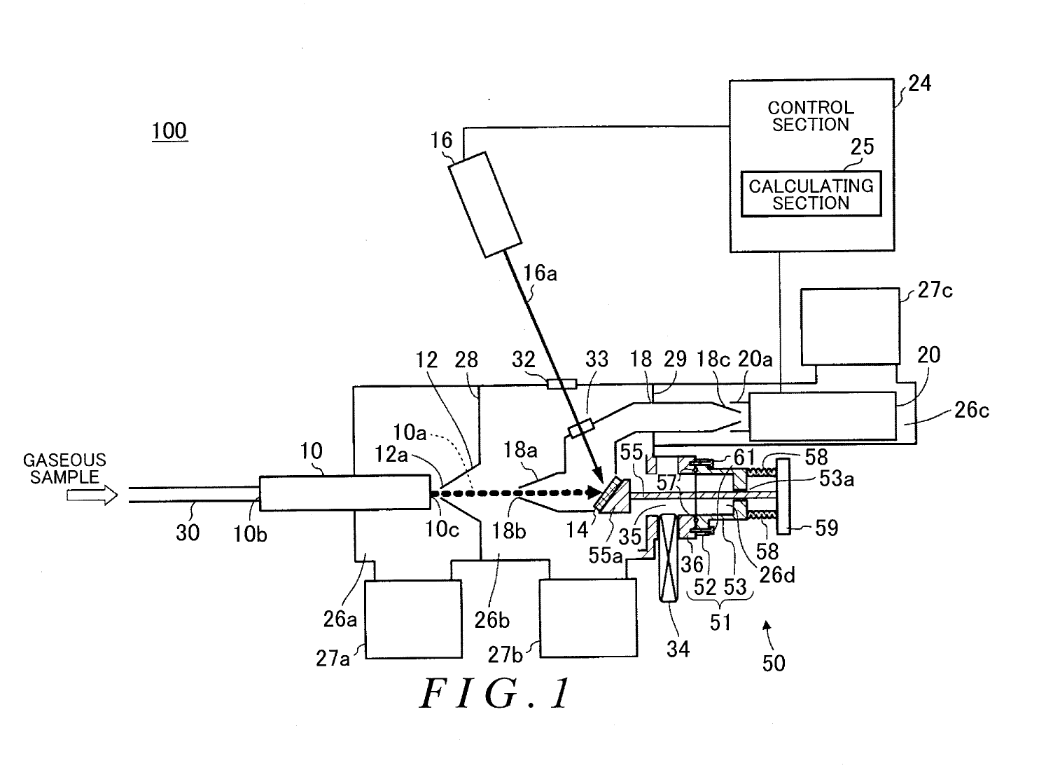

FIG. 1 is a schematic view representing a microparticle composition analyzing apparatus 100 when in use. The microparticle composition analyzing apparatus 100 is an apparatus for analyzing the composition and concentration of microparticles contained in a gaseous sample (aerosol).

The microparticle composition analyzing apparatus 100 mainly includes an aerodynamic lens 10, a skimmer 12, a trap 14, a laser device 16, an analysis cell 18, a gas analyzer 20, an inlet pipe 30, and a replacement mechanism 50. The microparticle composition analyzing apparatus 100 also includes a control section 24.

The microparticle composition analyzing apparatus 100 includes a depressurized chamber. The depressurized chamber includes a first depressurized chamber 26a, a second depressurized chamber 26b, a third depressurized chamber 26c, and a withdrawal chamber 26d. The first depressurized chamber 26a forms a first depressurized space therein. The second depressurized chamber 26b forms a second depressurized space therein. The third depressurized chamber 26c forms a third depressurized space therein. The withdrawal chamber 26d forms an auxiliary space therein. The first depressurized chamber 26a and the second depressurized chamber 26b are separated from each other by a first dividing wall 28. The second depressurized chamber 26b and the third depressurized chamber 26c are separated from each other by a second dividing wall 29. The withdrawal chamber 26d is spatially connected to the second depressurized chamber 26b via a communicating portion 35 during use.

The first depressurized chamber 26a includes a first exhaust apparatus 27a. The second depressurized chamber 26b includes a second exhaust apparatus 27b. The third depressurized chamber 26c includes a third exhaust apparatus 27c. The first exhaust apparatus 27a, the second exhaust apparatus 27b, and the third exhaust apparatus 27c respectively reduce the pressures of the first depressurized space, the second depressurized space, and the third depressurized space to be predetermined internal pressures that differ from each other. The predetermined internal pressures of the first depressurized space, the second depressurized space, and the third depressurized space are respectively 10⁻³ Torr, 10⁻⁵ Torr, and 10⁻⁷ Torr, for example. During use, the auxiliary space is in communication with the second depressurized space, and therefore the auxiliary space is depressurized in the same manner as the second depressurized space.

The aerodynamic lens 10 is arranged to be inserted into the first depressurized space from one side surface of the first depressurized chamber 26a. Specifically, an inlet side of the aerodynamic lens 10 through which the gaseous sample is introduced is arranged outside the first depressurized chamber 26a, and an emission hole 10c side of the aerodynamic lens 10 from which a particle beam 10a is emitted is arranged inside the first depressurized chamber 26a. The aerodynamic lens 10 is connected to the inlet pipe 30, which guide the gaseous sample. The aerodynamic lens 10 converges the microparticles contained in the gas introduced from the inlet pipe 30 end emits the converged microparticles as the particle beam 10a. In the microparticle composition analyzing apparatus 100, the aerodynamic lens 10 fulfills the role of an acquiring section that acquires the gaseous sample. The aerodynamic lens 10 is described in detail further below using the drawings.

The skimmer 12 is provided in the first dividing wall 28 separating the first depressurized chamber 26a and the second depressurized chamber 26b. The skimmer 12 is a conical structure provided with a communication hole 12a at the peak thereof, and is arranged such that the peak in which the communication hole 12a is formed points toward the emission hole 10c of the aerodynamic lens 10. As described above, since the internal pressure of the second depressurized space is set to be lower than the internal pressure of the first depressurized space, a gas flow from the first depressurized space to the second depressurized space occurs through the communication hole 12a. When the particle beam 10a emitted from the aerodynamic lens 10 passes through the communication hole 12a, the skimmer 12 removes a portion of excess gas contained in the particle beam 10a.

The analysis cell 18 has a front end arranged inside the second depressurized chamber 26b and a back end arranged in a manner to be inserted into the second dividing wall 29 separating the second depressurized chamber 26b and the third depressurized chamber 26c. A skimmer portion 18a is provided on the front end of the analysis cell 18. The skimmer portion 18a has a conical shape provided with a communication hole 18b at the peak, in the same manner as the skimmer 12. The communication hole 18b is arranged on a straight line connecting the emission hole 10c of the aerodynamic lens 10 with the communication hole 12a of the skimmer 12. The skimmer portion 18a further removes excess gas contained in the particle beam 10a.

The back end of the analysis cell 18 also forms a pointed tip, and a micro-hole 18c is formed in this end. In this way, by forming both ends of the analysis cell 18 as pointed tips, the microparticle composition analyzing apparatus 100 can maintain the pressure difference between the second depressurized space of the second depressurized chamber 26b and the third depressurized space of the third depressurized chamber 26c. Accordingly, the gas flow from the second depressurized chamber 26b toward the third depressurized chamber 26c occurs within the analysis cell 18. Furthermore, the trap 14 is arranged near a central portion of the analysis cell 18, and the analysis cell 18 forms an overall crank shape such that the gas generated by the trap 14 is gathered and directed toward the micro-hole 18c.

The trap 14 is arranged behind the skimmer portion 18a within the analysis cell 18. The trap 14 is arranged such that the surface thereof that traps microparticles diagonally intersects an inflow direction of the particle beam 10a. As described in detail further below, the trap 14 has a mesh structure and traps the microparticles contained in the particle beam 10a incident thereto.

Each individual microparticle contained in the particle beam 10a incident to the trap 14 collides with the mesh structure with a unique probability. A microparticle that has collided with the mesh structure then collides again with the mesh structure many times, and loses velocity with every collision. This microparticle gradually loses velocity until finally becoming trapped by the trap 14.

The laser device 16 is arranged outside the depressurized chamber 26. The laser device 16 oscillates the laser 16a. An optical window 32 is provided in a side wall of the second depressurized chamber 26b in contact with the outside atmosphere. An optical window 33 is provided in a side wall of the analysis cell 18. The laser device 16 irradiates the trap 14 with the laser 16a, after passing through the optical window 32 and the optical window 33, to heat an irradiation portion. In the present embodiment, the laser 16a is a carbon dioxide gas (CO₂) laser, as an example.

The laser device 16 vaporizes, excites, or causes a reaction in the microparticles trapped by the trap 14, using the laser 16a, thereby generating a gas that is a freed component. Here, the term “freed component” refers to a component that has been desorbed from the trapped state caused by the trap 14 and is in a movable state. In the following description, the gas that is a freed component when the gaseous sample is introduced may be referred to as the sample gas. As a specific example, the components of the sample gas are CO₂, H₂O, NO₂, SO₂, and the like caused by oxidization of the structural components of the microparticles.

The gas analyzer 20 is arranged inside the third depressurized chamber 26c. The gas analyzer 20 is an analyzer that analyzes the components of the introduced gas using mass spectrometry. Mass spectrometry has a minimum detection limit that is relatively low, and therefore can be suitably applied to gaseous samples with relatively low microparticle concentrations. An analyzer that analyzes gas using mass spectrometry is used in this example, but an analyzer that analyzes components of gas using another analysis method can be adopted instead, such as a method depending on the concentration or type of the microparticles in the gaseous sample serving as the analysis target. For example, when the analysis target has a high concentration of microparticles, an analyzer using spectroscopic analysis may be adopted.

The gas analyzer 20 has an ionization region 20a. The gas analyzer 20 is arranged such that the ionization region 20a is opposite the micro-hole 18c in the pointed tip formed at the back end of the analysis cell 18. The ionization region 20a ionizes the gas introduced from the analysis cell 18, and supplies the resulting ionized gas to the gas analyzer 20. The gas analyzer 20 periodically outputs to the calculating section 25 a strength signal corresponding to the amount of each component contained in the introduced gas.

The control section 24 performs comprehensive control of the operations and processes of each configurational component of the microparticle composition analyzing apparatus 100. For example, the control section 24 introduces the gaseous sample to the trap 14 according to a predetermined period and irradiates the trap 14 with the laser 16a. The control section 24 includes a calculating section 25 that calculates the output of the gas analyzer 20. The calculating section 25 performs various calculations using the strength signal corresponding to the content of specified components acquired from the gas analyzer 20 by the control section 24.

In the manner described above, the trap 14 traps the microparticles emitted from the aerodynamic lens 10 and is irradiated with the laser 16a. The energy of the laser 16a is high enough to instantaneously vaporize the microparticles. Accordingly, the mesh structure of the trap 14 is melted and altered according to the usage conditions and the like, thereby reducing the microparticle trapping capability. Furthermore, the laser 16a can also be radiated continuously, resulting in cases where heat shock is accumulated in the mesh structure. Yet further, there are cases where the mesh structure changes chemically due to the components of the trapped microparticles, and this can affect later analysis. Therefore, the trap 14 must be replaced with a new trap, either periodically or according to the amount of deterioration.

The trap 14 is arranged in the second depressurized space of the second depressurized chamber 26b, as described above, and therefore the second depressurized space must be opened to atmospheric pressure in order to extract the trap 14 in the conventional apparatus structure. Once the second depressurized space is opened to a general atmospheric pressure, vacuuming must be performed again by the second exhaust apparatus 27b in order to return to the depressurized state, and the time needed for this creates dead time for the measurement, thereby reducing the work efficiency. Furthermore, having the depressurized space exposed to the outside air can cause dirtying or deterioration of the internal components.

Therefore, the microparticle composition analyzing apparatus 100 according to the present embodiment includes the replacement mechanism 50 for replacing the trap 14. If the replacement mechanism 50 is used, it is possible to replace the trap 14 while maintaining the depressurized state of the second depressurized space.

The state shown in FIG. 1 represents a state in which the trap 14 is arranged at a predetermined regular position while the microparticle composition analyzing apparatus 100 is in use. In order to simplify the explanation, a cross section is shown in which a portion of the side walls of the second depressurized chamber 26b have a certain thickness. This cross-sectional portion is indicated by hatching, together with the cross section of the components of the replacement mechanism 50. The following describes the replacement mechanism 50 in this state.

The replacement mechanism 50 is mainly formed by a coupling portion 51, a bellows 58, a base flange 59, and a rod 55. The coupling portion 51 includes a connecting flange 52 and a trunk portion 53. The connecting flange 52 has a shape that expands from the trunk portion 53 to form a flange facing outward, and is secured to an attaching portion 36 provided on a side wall of the second depressurized chamber 26b via a screw 61. The coupling portion 51 is provided with an open internal space on the attaching portion 36 side. This internal space is an auxiliary space into which the trap 14 withdraws, as described further below. The coupling portion 51 is formed by a high-strength material, e.g. duralumin, and the auxiliary space functions as the withdrawal chamber 26d that withstands depressurization. An O-ring 57 is provided on the surface of the connecting flange 52 contacting the attaching portion 36, in a manner to surround the opening of the auxiliary space. By pressing and screwing in the O-ring 57, the auxiliary space is maintained in an air-tight state.

The rod 55 is provided in a manner to penetrate through the inside of the withdrawal chamber 26d, and the back end side thereof protrudes from a through-hole 53a provided in the back end side of the coupling portion 51, i.e. the side opposite the attaching portion 36 side. The rod 55 can be guided by the through-hole 53a and moved in its axial direction. The back end of the rod 55 is secured to the base flange 59. When a user grips and pushes or pulls on the base flange 59, the user can move the rod 55 in the axial direction.

The back end of the coupling portion 51 and the base flange 59 are connected by a bellows 58 forming a bellows mechanism. The rod 55 is positioned inside the bellows 58. The internal space through which the rod 55 penetrates, which is the space where the bellows 58 surrounds the back end of the coupling portion 51 and the base flange 59, has sealing applied thereto in a manner to from an air-tight space that also withstands depressurization. As shown by the state in the drawing, in a state where the user has pressed in the rod 55, the bellows mechanism of the bellows 58 folds in. This internal space is made into an air-tight space by being in communication with the auxiliary space via the through-hole 53a, and because it is possible for this internal space to become a portion of the withdrawal chamber 26d.

A gate valve 34 is provided adjacent to the attaching portion 36. The gate valve 34 is a movable dividing wall that spatially connects or divides the second depressurized space of the second depressurized chamber 26b to and from the auxiliary space of the withdrawal chamber 26d. FIG. 1 shows a state in which the gate valve 34 is withdrawn and the second depressurized space and auxiliary space are in a connected state. Accordingly, the auxiliary space is also depressurized to the same pressure as the second depressurized space by the second exhaust apparatus 27b.

A head 55a for supporting the trap 14 is provided on the tip of the rod 55. The attachment surface of the trap 14 is formed to be inclined at a predetermined angle relative to the axial direction of the rod. A positioning pin is provided on the back surface side of the trap 14 in contact with the attachment surface, and the trap 14 is secured to the attachment surface by engaging this positioning pin with a positioning hole provided in the attachment surface. The securing method is not limited to this, and a variety of methods can be adopted. For example, securing may be achieved using an adhesive.

The rod 55 has a lock mechanism that regulates movement, such that the trap 14 is statically positioned at a predetermined regular position. The lock mechanism is formed, for example, by a hook that restricts a bias force exerted by the folded bellows 58 attempting to open, and stops the bellows 58 at a prescribed position. As another example, a plurality of stop positions may be set for the rod 55, such that the rod 55 is stopped at the plurality of positions according to the type of trap 14. In this case, it is only necessary to provide a plurality of hook latching portions according to the stop positions.

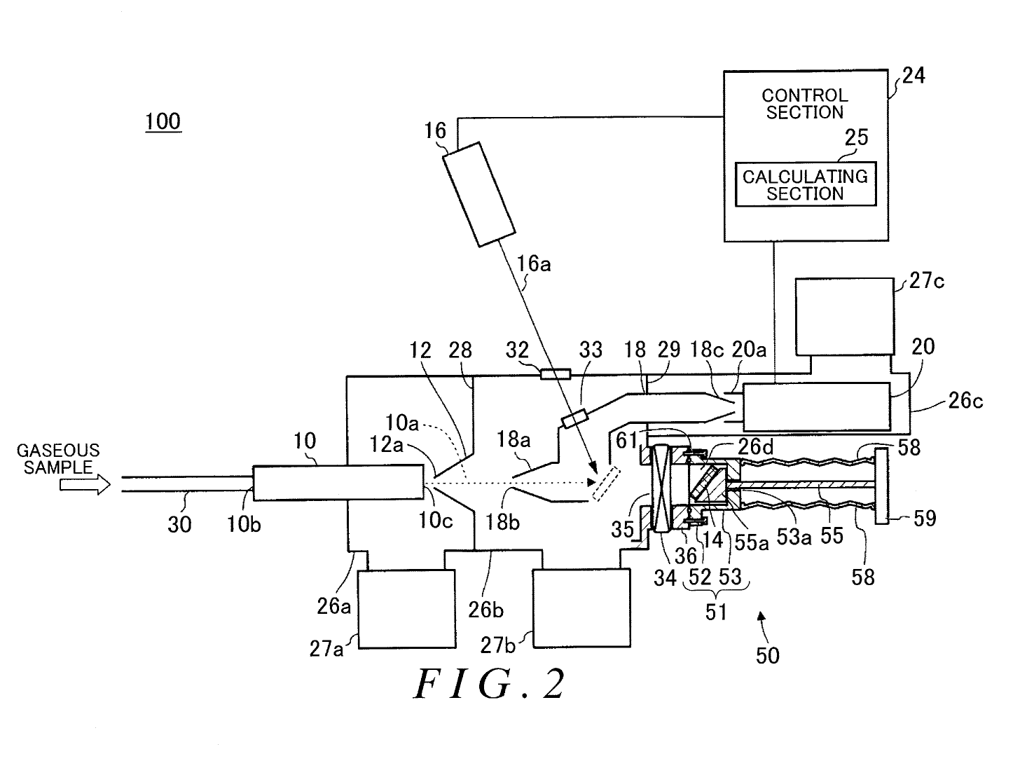

FIG. 2 is a schematic view representing the microparticle composition analyzing apparatus 100 during replacement of the trap 14. When the user pulls the base flange 59 outward, which is a direction away from the attaching portion 36, the bellows mechanism of the bellows 58 opens, and the rod 55 also moves outward. The head 55a eventually reaches a region near the opening of the through-hole 53a, and the head 55a becomes housed together with the trap 14 in the auxiliary space of the withdrawal chamber 26d.

When the trap 14 is housed in the auxiliary space, the user moves the gate valve 34 inward to switch to a state where the second depressurized space and the auxiliary space are isolated from each other. After switching to the isolated state, if the screw 61 is removed, the replacement mechanism 50 can be separated from the microparticle composition analyzing apparatus 100. At this time, the outside air does not enter into the second depressurized space because an air-tight space is realized using the gate valve 34, and the depressurized state is maintained.

When the replacement mechanism 50 is separated, the withdrawal chamber 26d is opened to the atmospheric pressure, and the user can remove the trap 14. The bellows mechanism of the bellows 58 may be slightly folded and the trap 14 may protrude slightly from the withdrawal chamber 26d, such that the trap 14 becomes easy to remove.

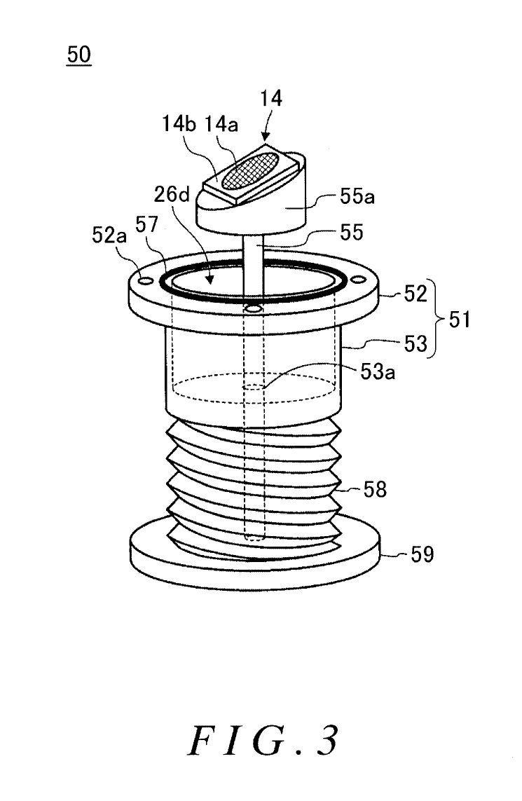

FIG. 3 is an external perspective view of the replacement mechanism 50. As shown in the drawing, the four screw holes 52a through which screws 61 penetrate are provided in a circumferential direction in the connecting flange 52. Furthermore, the trunk portion 53 is formed as a cylinder, and is formed integrally with the connecting flange 52 to realize the coupling portion 51. The inside of the coupling portion 51 has an overall function of the withdrawal chamber 26d, by having the auxiliary space formed therein.

The trunk portion 53 is shaped as a cup with the opening on the connection portion side, and a through-hole 53a is provided in the central portion of the bottom of the cup. In the present embodiment, the bottom portion is formed to have a thickness, i.e. the through-hole 53a is formed to be deep, to ensure the engagement length of the rod 55, such that the rod 55 progresses stably in the axial direction. In other words, the through-hole 53a serves as a guide portion for the rod 55. However, if another guide portion is provided, the trunk portion 53 need not be formed with a cup shape, and instead the trunk portion 53 may be formed with a cylindrical shape and may form the auxiliary space together with the internal space of the bellows 58, for example.

The following describes the trap 14. The trap 14 is a unit for trapping microparticles contained in the gaseous sample that is the analysis target. The trap 14 includes a mesh 14a, which is a main body for trapping microparticles, and a support frame 14b that supports the mesh 14a. The mesh 14a is from φ 3 mm to φ 8 mm, overall, and may use a non-woven fabric formed by fibers of metal, an alloy, or compounds thereof. A mesh sheet formed by fine machining may be used. The line width of the mesh is from 1 μm to 10 μm, and the holes are formed as quadrangles with side lengths from 10 μm to 100 μm. A plurality of meshes may be stacked in layers. The support frame 14b is a quadrangle with horizontal and vertical sides from 5 mm to 8 mm and a thickness of approximately 100 μm to 300 μm. The trap 14 may be formed by stacking a plurality of support frames 14b onto which the mesh 14a is stretched. If the mesh 14a is stacked to form layers, the different layers may have different hole sizes.

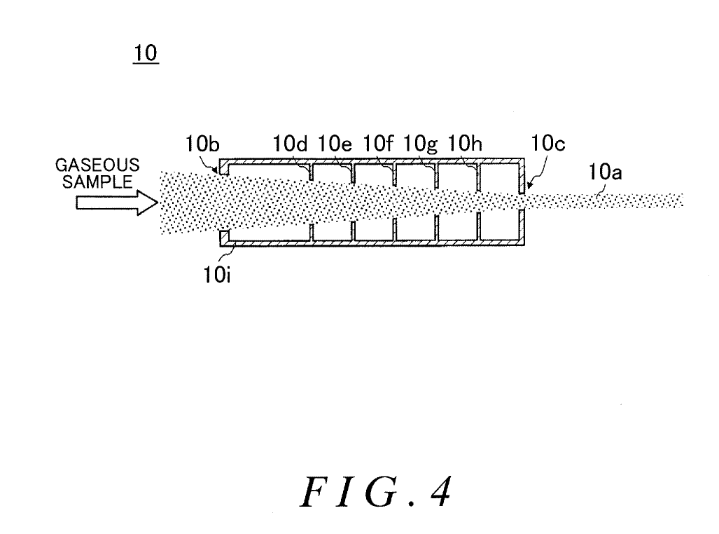

The following describes the aerodynamic lens 10. FIG. 4 is a schematic view for describing the aerodynamic lens 10. The aerodynamic lens 10 has a casing 10i with a cylindrical external structure. The inlet 10b, through which the gaseous sample or the like is introduced form the outside, is provided on a side surface at one end of the casing 10i. The emission hole 10c, which emits the particle beam 10a, is provided on a side surface at the other end of the casing 10i. The aerodynamic lens 10 includes orifices 10d, 10e, 10f, 10g, and 10h in the casing 10i. The orifices 10d to 10h are each a donut-shaped plate having a through-hole in the center thereof. As shown in FIG. 2, these through-holes are formed to have respectively smaller diameters in order from the orifice 10d to the orifice 10h.

As described using FIG. 1, the inlet 10b and the emission hole 10c are arranged respectively outside and inside the first depressurized chamber 26a. Accordingly, due to the pressure difference between the inlet 10b and the emission hole 10c, the gaseous sample flows from the inlet 10b toward the emission hole 10c. Upon passing through the aerodynamic lens 10, the air that is the medium of the gaseous sample moves while scattering. Therefore, the movement of the air that is a gas is impeded by each orifice.

On the other hand, the microparticles formed of solids or liquids have a strong linear progression characteristic. Therefore, after having passed through the first-stage aerodynamic lens 10, the movement of the microparticles is not significantly impeded by the second-stage and later orifices 10e to 10h. Furthermore, since the diameters of the through-holes become progressively smaller from the orifice 10d toward the orifice 10h as described above, the flow path constricts from the inlet 10b toward the emission hole 10c. Accordingly, the microparticles contained in the gaseous sample introduced from the inlet 10b are emitted from the emission hole 10c arranged in a beam shape.

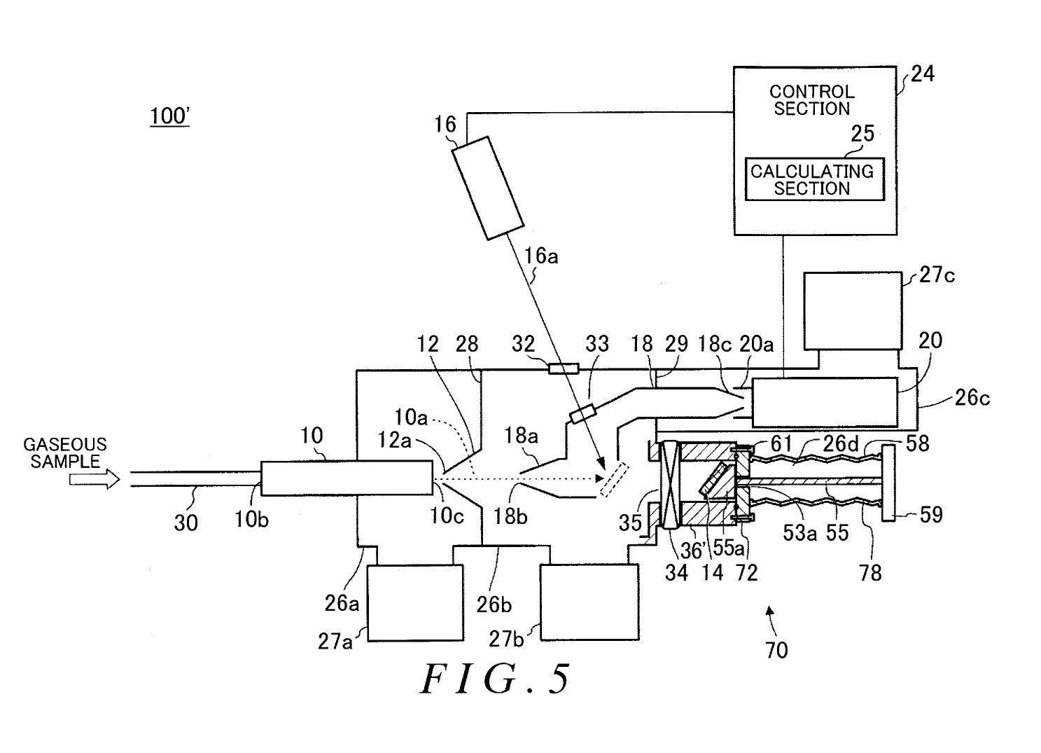

The following describes a modification. FIG. 5 is a schematic view representing a microparticle composition analyzing apparatus 100′ according to a modification. In particular, a state during the replacement of the trap 14 is represented, in the same manner as in FIG. 2. The difference between the modification and the embodiment described above is that the attaching portion 36′ forms a portion of the auxiliary space and the trap 14 withdraws into this auxiliary space. In the replacement mechanism 50 described above, the coupling portion 51 includes the trunk portion 53 and the auxiliary space is formed within this trunk portion, but in the replacement mechanism 70 according to this modification, the coupling portion is formed by the connecting flange 72 alone. Accordingly, the bellows mechanism of the bellows 78 is longer by a corresponding amount than the bellows mechanism of the bellows 58 of the replacement mechanism 50,

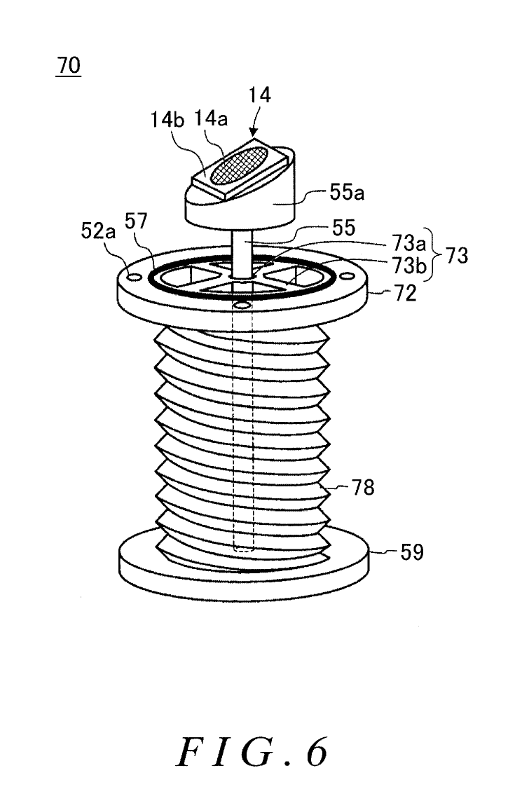

FIG. 6 is an external perspective view of the replacement mechanism 70 according to a modification. The replacement mechanism 70 differs from the replacement mechanism 50 by including a guide portion 73. The guide portion 73 includes a cylinder 73a for guiding the rod 55 in a central portion of the opening of the connecting flange 72. Furthermore, the guide portion 73 includes four joists 73b that support the cylinder 73a from the connecting flange 72. The bellows 78 is sealed by being attached to the connecting flange 72. The remaining configuration of the replacement mechanism 70 is the same as that of the replacement mechanism 50, and therefore the same reference numerals are used and further description is omitted.

When the replacement mechanism 70 is attached to the attaching portion 36′, the space formed by the attaching portion 36′ is in communication with the space inside the bellows 78. The components become integrated to form the auxiliary space, and when the microparticle composition analyzing apparatus 100′ is in use, this auxiliary space is depressurized together with the second depressurized space. In this case, the bellows 78 can be said to form a portion of the connection portion.

In the microparticle composition analyzing apparatuses 100 and 100′ described above, the user moves the rod 55 by grasping and pushing or pulling the base flange 59, but instead the rod 55 may be moved by an actuator. For example, if axial portions of the rod 55 are magnetized to be N poles and S poles in an alternating manner along the axial direction and an external coil is controlled to apply magnetism, it is possible to move the rod 55 in a non-contact manner. If the rod 55 is moved by an actuator, control needs only be performed by the control section 24.

In the microparticle composition analyzing apparatuses 100 and 100′ described above, the head 55a supports the trap 14 during use as well, but the trap 14 may be separated from the head 55a and the rod 55 may be withdrawn during use. In this case, the head 55a is provided with a separation mechanism to be separated from the trap 14. For example, the back surface of the trap 14 is made of a magnetic material and the head 55a is made of a magnet. When the trap 14 reaches the regular position, the electromagnetic operation is stopped and the trap 14 becomes separated.

In the microparticle composition analyzing apparatuses 100 and 100′ described above, the auxiliary space is also depressurized by the second exhaust apparatus 27b, but instead an auxiliary pump may be included to depressurize the auxiliary space. If the auxiliary pump is included, when the trap 14 is arranged at the regular position in the second depressurized space after replacement, the auxiliary space can be depressurized before opening the gate valve 34, and therefore the depressurized state of the second depressurized space can be kept constant. The gate valve 34 is not limited to a type that must be completely withdrawn from the communicating portion 35, and instead a type may be used in which a communication state is realized when two rotational plates are in accordance with a first phase and an isolated state is realized when the two rotational plates are in accordance with a second phase.

The above embodiments describe a case where the replacement mechanisms 50 and 70 are applied in the microparticle composition analyzing apparatuses 100 and 100′, but instead the replacement mechanisms 50 and 70 can be applied in various apparatuses in which a trap 14 for trapping microparticles is used in depressurized state. In an apparatus that requires the trapping of microparticles, there is usually a demand for the replacement of the trap to be performed efficiently, and therefore the present invention is not limited to microparticle analyzing devices and can be developed in the same manner for other apparatuses.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

### LIST OF REFERENCE NUMERALS

10: aerodynamic lens, 10a: particle beam, 10b: inlet, 10c: emission hole, 12: skimmer, 12a: communication hole, 14: trap, 14a: mesh, 14b: support frame, 16: laser device, 16a: laser, 18: analysis cell, 18a: skimmer portion, 18b: communication hole, 18c: micro-hole, 20: gas analyzer, 20a: ionization region, 24: control section, 25: calculating section, 26a: first depressurized chamber, 26b: second depressurized chamber, 26c: third depressurized chamber, 26d: withdrawal chamber, 27a: first exhaust apparatus, 27b: second exhaust apparatus, 27c: third exhaust apparatus, 28: first dividing wall, 29: second dividing wall, 30: inlet pipe, 32: optical window, 33: optical window, 34: gate valve, 35: communicating portion, 36, 36′: attaching portion, 50: replacement mechanism, 51: coupling portion, 52: connecting flange, 52a: screw hole, 53: trunk portion, 53a: through-hole. 55: rod, 55a: head, 57: O-ring, 58: bellows, 59: base flange, 61: screw, 70: replacement mechanism, 72: connecting flange, 73: guide portion, 73a: cylinder, 73b: joist: 78: bellows, 100, 100′: microparticle composition analyzing apparatus

What is claimed is:

1. A trap replacement mechanism comprising:
a rod that supports a trap for trapping microparticles; and
a connection portion that includes at least a portion of an auxiliary space connected to a depressurized space in which the trap is provided, wherein
the trap can be withdrawn from the depressurized space to the auxiliary space side and opened to atmospheric pressure while the depressurized space is kept in a depressurized state, by moving the rod.

2. The trap replacement mechanism according to claim 1, wherein
the connection portion includes a bellows mechanism, and
an internal space of the bellows mechanism also functions as the auxiliary space.

3. The trap replacement mechanism according to claim 1, wherein
the connection portion includes a coupling portion for connecting to a depressurized chamber forming the depressurized space, and at least a portion of the auxiliary space is formed inside the coupling portion.

4. The trap replacement mechanism according to claim 1, wherein
the rod is capable of adjusting an arrangement position of the trap within the depressurized space.

5. The trap replacement mechanism according to claim 1, wherein
the rod is capable of supporting and being separated from the trap within the depressurized space.

6. The trap replacement mechanism according to claim 1, comprising:
an auxiliary pump that depressurizes the auxiliary space.

7. The trap replacement mechanism according to claim 1, comprising:
a gate valve that switches between a connected state and an isolated state realized between the depressurized space and the auxiliary space, wherein
the gate valve switches from the connected state to the isolated state after the trap has withdrawn into the auxiliary space.

8. A microparticle composition analyzing apparatus comprising:
the trap replacement mechanism according to claim 1;
the trap;
an exhaust apparatus that depressurizes the depressurized space;
an introducing section that acquires and converges a gaseous sample containing the microparticles and discharges the converged gaseous sample toward the trap;
a laser device that irradiates the trap with laser; and
a gas analyzer that analyzes a sample gas generated as a result of irradiation with the laser.
